(19) United States
(12) Patent Application Publication
(10) Pub. No.: US 2016/0202460 A1
(43) Pub. Date: Jul. 14, 2016

(54) 3D Microscopy With Illumination Engineering

(71) Applicant: University of Connecticut, Farmington, CT (US)

(72) Inventor: Guoan Zheng, Vernon, CT (US)

(73) Assignee: University of Connecticut, Farmington, CT (US)

(21) Appl. No.: 14/993,290

(22) Filed: Jan. 12, 2016

Related U.S. Application Data
(60) Provisional application No. 62/102,906, filed on Jan. 13, 2015.

(51) Int. Cl. G02B 21/00; H04N 5/225

(52) U.S. Cl. CPC G02B 21/004; H04N 5/2256; G02B 21/0032; G02B 21/0076; G02B 13/0095

(57) ABSTRACT

The present disclosure provides improved microscopic imaging techniques, equipment and systems. More particularly, the present disclosure provides advantageous microscopy assemblies with illumination engineering (e.g., 3D microscopy assemblies with illumination engineering), and related methods of use. Disclosed herein is an imaging technique/assembly that uses a spatial light modulator (“SLM”) for 3D tomographic imaging with brightfield or fluorescence illumination that can also be utilized for bright-field, dark-field, phase-contrast, and super-resolution microscopy. Disclosed herein are methods and instrumentation/assemblies having preferred uses for 3D tomographic imaging, and phase-contrast and super-resolution imaging. The present disclosure advantageously provides for assemblies and methods configured to create 3D tomographic images by way of acquiring a series of images with varied angle illumination using a SLM and computational reconstruction that substantially eliminates the need to move the sample. The disclosed assemblies and methods are also able to acquire bright-field, dark-field, various contrast, and super-resolution images.

### CROSS-REFERENCE TO RELATED APPLICATIONS

This application claims priority to Provisional Application Ser. No. 62/102,906 filed Jan. 13, 2015, the contents of which is hereby incorporated by reference in its entirety.

### FIELD OF THE DISCLOSURE

The present disclosure relates generally to the field of microscopic imaging techniques, equipment and systems and, more particularly, to microscopy/imaging assemblies with illumination engineering (e.g., three-dimensional microscopy/imaging assemblies with illumination engineering).

### BACKGROUND OF THE DISCLOSURE

In general, equipment and procedures in the field of microscopic imaging are known.

However, it is noted that capturing 3D images of samples generally requires the movement of the microscope stage or the optics to acquire images at various focal positions. These methods typically require either a motorized stage or focus mechanism, both of which can be expensive and not available for all microscopes.

Moreover, known types of microscopes generally use a range of hardware accessories to create contrast, 3D, or wide field images of samples. These accessories can be expensive and in some cases mutually exclusive.

As such, a need exists among end-users and/or manufacturers to develop microscopy/imaging assemblies that include improved features/structures. In addition, a need remains for instruments, assemblies and methods that allow microscopic imaging techniques through designs and techniques that are easily understood and implemented.

Thus, an interest exists for improved microscopy/imaging assemblies and related methods of use. These and other inefficiencies and opportunities for improvement are addressed and/or overcome by the assemblies, systems and methods of the present disclosure.

### SUMMARY OF THE DISCLOSURE

According to the present disclosure, advantageous instruments, assemblies and methods are provided for undertaking microscopic imaging techniques.

The present disclosure provides improved microscopic imaging techniques, equipment and systems. More particularly, the present disclosure provides advantageous microscopy/imaging assemblies with illumination engineering (e.g., 3D microscopy/imaging assemblies with illumination engineering).

Disclosed herein is an imaging technique/assembly that uses a spatial light modulator (“SLM”) (e.g., a digitally controlled SLM) for three-dimensional (“3D”) tomographic imaging with brightfield or fluorescence illumination that can also be utilized for bright-field, dark-field, phase-contrast, and super-resolution microscopy. Disclosed herein are methods and instrumentation/assemblies having preferred uses for 3D tomographic imaging, and phase-contrast and super-resolution imaging.

In exemplary embodiments, the assemblies, methods and equipment disclosed herein use a spatial light modulator (SLM), such as a liquid crystal display (LCD) or digital micro-mirror device (DMD), to digitally manipulate the illumination of the sample. As discussed further below, the use of a single light source and a SLM has several advantages.

The present disclosure provides for an imaging assembly including a light source and an imaging sensor; a condenser, a detection optics member and a tube lens or camera adapter, the condenser, detection optics member and the tube lens or camera adapter positioned between the light source and the imaging sensor; and a digitally controlled spatial light modulator positioned between the light source and the imaging sensor, the digitally controlled spatial light modulator configured and adapted to provide three-dimensional tomographic imaging of a sample.

The present disclosure also provides for an imaging assembly wherein the digitally controlled spatial light modulator is a liquid crystal display or a digital micro-mirror device. The present disclosure also provides for an imaging assembly wherein the three-dimensional tomographic imaging of the sample utilizes computational image reconstruction with brightfield or fluorescence illumination.

The present disclosure also provides for an imaging assembly wherein the digitally controlled spatial light modulator is configured and adapted to provide illumination modulation. The present disclosure also provides for an imaging assembly wherein the three-dimensional tomographic imaging of the sample utilizes brightfield illumination, fluorescence illumination or epifluorescence illumination.

The present disclosure also provides for an imaging assembly wherein the digitally controlled spatial light modulator is positioned between the light source and the condenser. The present disclosure also provides for an imaging assembly wherein the digitally controlled spatial light modulator is positioned at the back focal plane of the condenser.

The present disclosure also provides for an imaging assembly wherein the digitally controlled spatial light modulator is positioned at the back focal plane of the detection optics member. The present disclosure also provides for an imaging assembly wherein the digitally controlled spatial light modulator is positioned between the detection optics member and the tube lens or camera adapter.

The present disclosure also provides for an imaging assembly wherein the digitally controlled spatial light modulator is positioned between the tube lens or camera adapter and the imaging sensor. The present disclosure also provides for an imaging assembly wherein the digitally controlled spatial light modulator is a slider member having an integrated liquid crystal display and electronics, the slider member configured and dimensioned to be inserted into the light path of the light source for imaging purposes.

The present disclosure also provides for an imaging assembly wherein the digitally controlled spatial light modulator is a slider member having an integrated liquid crystal display and electronics, the slider member configured and dimensioned to be positioned between the detection optics member and the tube lens or camera adapter for imaging purposes.

The present disclosure also provides for an imaging assembly wherein the digitally controlled spatial light modulator is a slider member having an integrated liquid crystal display and electronics, the slider member configured and dimensioned to be positioned between the tube lens or camera adapter and the imaging sensor for imaging purposes.

The present disclosure also provides for an imaging method, including providing a light source and an imaging sensor; providing a condenser, a sample, a detection optics member and a tube lens or camera adapter, the condenser, sample, detection optics member and the tube lens or camera adapter positioned between the light source and the imaging sensor; positioning a digitally controlled spatial light modulator between the light source and the imaging sensor; and providing three-dimensional tomographic imaging of the sample via the digitally controlled spatial light modulator.

The present disclosure also provides for an imaging method wherein the digitally controlled spatial light modulator is configured and adapted to provide illumination modulation; and wherein the digitally controlled spatial light modulator is a liquid crystal display or a digital micro-mirror device.

The present disclosure also provides for an imaging method wherein the three-dimensional tomographic imaging of the sample utilizes computational image reconstruction with brightfield or fluorescence illumination. The present disclosure also provides for an imaging method wherein the three-dimensional tomographic imaging of the sample utilizes brightfield illumination, fluorescence illumination or epifluorescence illumination.

The present disclosure also provides for an imaging method wherein the digitally controlled spatial light modulator is positioned between the light source and the condenser. The present disclosure also provides for an imaging method wherein the digitally controlled spatial light modulator is positioned between the detection optics member and the tube lens or camera adapter. The present disclosure also provides for an imaging method wherein the digitally controlled spatial light modulator is positioned between the tube lens or camera adapter and the imaging sensor.

The present disclosure also provides for an imaging method wherein the digitally controlled spatial light modulator is a slider member having an integrated liquid crystal display and electronics, the slider member configured and dimensioned to be inserted into the light path of the light source for imaging purposes.

The present disclosure also provides for an imaging assembly including a light source and an imaging sensor; a condenser, a detection optics member and a tube lens or camera adapter, the condenser, detection optics member and the tube lens or camera adapter positioned between the light source and the imaging sensor; and a digitally controlled liquid crystal display positioned between the light source and the imaging sensor, the digitally controlled liquid crystal display configured and adapted to provide three-dimensional tomographic imaging of a sample using computational image reconstruction with brightfield or fluorescence illumination; wherein the digitally controlled liquid crystal display is configured and adapted to provide illumination modulation; and wherein the digitally controlled liquid crystal display is positioned at the back focal plane of the condenser.

Any combination or permutation of embodiments is envisioned. Additional advantageous features, functions and applications of the disclosed systems, assemblies and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

Features and aspects of embodiments are described below with reference to the accompanying drawings, in which elements are not necessarily depicted to scale.

Exemplary embodiments of the present disclosure are further described with reference to the appended figures. It is to be noted that the various features, steps and combinations of features/steps described below and illustrated in the figures can be arranged and organized differently to result in embodiments which are still within the scope of the present disclosure. To assist those of ordinary skill in the art in making and using the disclosed systems, assemblies and methods, reference is made to the appended figures, wherein:

FIG. 1 shows an exemplary scheme/assembly using a low-cost liquid crystal display at the condenser diaphragm; an LCD is placed at the back focal plane of the condenser lens;

FIG. 2 shows that different patterns can be displayed for achieving different microscopy modalities; different patterns can be set on the LCD for achieving different microscopy imaging modalities;

FIG. 3 shows an exemplary experimental setup with a green LED as the light source, and a liquid crystal display (with back light removed) is placed at the back-focal plane of the condenser lens; FIG. 3 shows an exemplary experimental setup for an upright microscope;

FIGS. 4A1-4D2: FIGS. 4A1 to 4A3 show bright-field images; FIG. 4B shows a dark-field image; FIGS. 4C1 and 4C2 show phase-contrast imaging using the disclosed scheme, with 4C1 and 4C2 showing the phase gradient images along two different directions; 4D1 and 4D2 show polarization microscopy images using an added polarizer at the detection path; a 10×, 0.25 objective was utilized and using the proposed LCD-based setups;

FIGS. 5A-5D show 3D tomographic reconstruction (3D tomography imaging) using an exemplary disclosed scheme; 49 images were captured by presenting a scanning aperture at the transparent liquid crystal display; these images were used to recover sample images at different sections; the entire digital refocusing process was from −40 μm to +40 μm; a 10×, 0.25 objective was utilized and using the proposed LCD-based setups;

FIGS. 6A1 to 6C2 show super-resolution imaging using the reported scheme; 121 images were captured by presenting a scanning aperture at the transparent liquid crystal display; these images were used to recover super-resolution images using the Fourier ptychographic algorithm; FIGS. A1, B1 and C1 show raw images for a USAF resolution target, a pathology slide, and a mouse brain section; FIGS. A2, B2 and C2 show recovered super-resolution images of the samples;

FIG. 7 shows another exemplary experimental setup for an inverted microscope, and a LCD is placed at the back focal plane of the condenser lens;

FIGS. 8A-8B show recovered images of a pap smear that demonstrate the depth-of-field extension using a 3D tomographic reconstruction routine; by comparison and as shown in FIG. 8C, a conventional incoherent brightfield image uses a relatively large illumination NA to produce a smaller depth of field; a 40×, 0.75 objective was utilized in this demonstration; and

FIGS. 9-12 show various exemplary imaging assemblies of the present disclosure.

### DETAILED DESCRIPTION OF DISCLOSURE

The exemplary embodiments disclosed herein are illustrative of advantageous microscopy/imaging assemblies, and systems of the present disclosure and methods/techniques thereof. It should be understood, however, that the disclosed embodiments are merely exemplary of the present disclosure, which may be embodied in various forms. Therefore, details disclosed herein with reference to exemplary imaging assemblies/fabrication methods and associated processes/techniques of assembly and use are not to be interpreted as limiting, but merely as the basis for teaching one skilled in the art how to make and use the advantageous imaging assemblies/systems and/or alternative assemblies of the present disclosure.

The present disclosure provides improved microscopic imaging techniques, equipment and systems. More particularly, the present disclosure provides advantageous microscopy/imaging assemblies with illumination engineering (e.g., 3D microscopy/imaging assemblies with illumination engineering), and related methods of use.

In exemplary embodiments, the present disclosure provides for an imaging technique/assembly that uses a spatial light modulator (“SLM”) (e.g., a digitally controlled SLM) for 3D tomographic imaging with brightfield or fluorescence illumination. It is noted that the exemplary imaging technique/assembly that uses a SLM with brightfield or fluorescence illumination can also be utilized for bright-field, dark-field, phase-contrast, and super-resolution microscopy.

In certain embodiments, the present disclosure provides for methods and instrumentation/assemblies that are configured and adapted for 3D tomographic imaging, and phase-contrast and super-resolution imaging.

Current practice provides that capturing 3D images of samples generally requires the movement of the microscope stage or the optics to acquire images at various focal positions, and these methods typically require either a motorized stage or focus mechanism, both of which can be expensive and not available for all microscopes.

In general, the present disclosure advantageously provides for assemblies, systems and methods configured and dimensioned to create 3D tomographic images by way of acquiring a series of images with varied angle illumination using a SLM and computational reconstruction that substantially eliminates the need to move the sample, thereby providing a significant operational and/or commercial advantage as a result. It is noted that the disclosed assemblies, methods and instrumentation are also able to acquire bright-field, dark-field, various contrast, and super-resolution images.

Moreover, the disclosed assemblies, methods and instrumentation are compatible with conventional platforms for microscopy. In general, no major hardware modifications are needed. The disclosed assemblies, methods and instrumentation also provide cost advantages compared to other conventional approaches.

Furthermore, known types of microscopes can use a range of hardware accessories to create contrast, 3D, or wide field images of samples. These accessories can be expensive and in some cases mutually exclusive.

In exemplary embodiments, the assemblies, methods and equipment disclosed herein use a spatial light modulator (SLM), such as a liquid crystal display (LCD) or digital micro-mirror device (DMD), to digitally manipulate the illumination of the sample. In contrast to a previously described approach using an LED array for 3D tomographic imaging (Zheng et al., Microscopy Refocusing And Dark-Field Imaging By Using A Simple LED Array, OPTICS LETTERS, Vol. 36(20) 2011), the use of a single light source and a SLM has several advantages over the use of an LED array.

In exemplary embodiments, the SLM requires less space, offers greater flexibility in adjusting the illumination to the various detection optics used, and delivers more uniform illumination to the sample (See Example 1 below; and see Guo et al., Microscopy Illumination Engineering Using A Low-Cost Liquid Crystal Display, Biomedical Optics Express Vol. 6 (2) 2015). Furthermore, the assembly/method allows the SLM to be added as an accessory to existing microscopes as a low-cost alternative to traditional hardware accessories (See Example 2 below; and see Bian et al., Illumination Control/Computational Imaging: Multimodal Microscopy Using A Low-Cost Liquid Crystal Display, Laser Focus World, 51 (10) 2015). It is noted that all references and publications listed in this disclosure are hereby incorporated by reference in their entireties.

The present disclosure will be further described with respect to the following examples; however, the scope of the disclosure is not limited thereby. The following examples illustrate the advantageous microscopic imaging assemblies and methods of the present disclosure.

### Example 1

### Microscopy Illumination Engineering Using a Low-Cost Liquid Crystal Display

In general, illumination engineering is important for obtaining high-resolution, high-quality images in microscope settings. In a typical microscope, the condenser lens provides sample illumination that is uniform and free from glare. The associated condenser diaphragm can be manually adjusted to obtain the optimal illumination numerical aperture. In this Example, a programmable condenser lens for active illumination control is disclosed. In an exemplary prototype setup, an inexpensive liquid crystal display was utilized as a transparent spatial light modulator, and it was placed at the back focal plane of the condenser lens. By setting different binary patterns on the display, one can actively control the illumination and the spatial coherence of the microscope platform. As such, the use of this scheme for multimodal imaging, including bright-field microscopy, darkfield microscopy, phase-contrast microscopy, polarization microscopy, 3D tomographic imaging, and superresolution Fourier ptychographic imaging is demonstrated. The exemplary illumination engineering scheme is cost-effective and compatible with most existing platforms. It enables a turnkey solution with high flexibility for researchers in various communities. From an engineering point-of-view, the disclosed illumination scheme may also provide new insights for the development of multimodal microscopy and Fourier ptychographic imaging.

### Introduction:

The condenser lens system is a ubiquitous component of conventional microscope platforms for uniform sample illumination. It typically consists of a high numerical aperture (NA) condenser lens and a condenser diaphragm placed at the back focal plane of the lens. This condenser diaphragm allows for manual adjustment of the optimal illumination aperture, which defers with different microscopy techniques. In bright-field microscopy, the illumination NA should be matched to the collection NA by adjusting the size of the condenser diaphragm. In dark-field microscopy, an aperture stop is placed at the condenser diaphragm to ensure the illumination NA is larger than the collection NA. In phase-contrast microscopy, a ring aperture is placed at the condenser diaphragm to match to the ring-shape phase plate of the objective lens. In short, each microscopy technique requires vastly different condenser illumination. Currently, these requirements are met by physical adjustment of condenser diaphragms and, in some cases, a need for specialized condenser apertures. However, with liquid crystal displays, there exists an opportunity for cost-effective, active digital control of the illumination system.

In this Example, the use of an inexpensive liquid crystal display to achieve programmable condenser illumination control is disclosed. In an exemplary prototype setup, the display was placed at the back focal plane of the condenser lens. By setting different binary patterns on the display, one can actively control the illumination and the spatial coherence of the microscope platform. To demonstrate the versatility of the exemplary scheme, one can use the prototype platform for multimodal microscopy imaging, including bright-field microscopy, darkfield microscopy, polarization microscopy, phase-contrast microscopy, 3D tomographic imaging, and super-resolution Fourier ptychographic imaging. Essentially, the exemplary liquid crystal display (with the back light removed) serves as a transparent spatial light modulator (SLM) in the disclosed scheme. The use of SLM in microscopy has drawn attention in recent years. However, in these conventional techniques, the SLMs are placed in the detection path to modulate the pupil function or to project intensity patterns onto the sample. This is the first disclosure of the use of an SLM for the modulation of the condenser illumination.

Although the active illumination control for microscopy setting using an LED array have been reported, the technique disclosed herein has some important advantages over the previous demonstrations.

First, the disclosed technique/assembly is cost-effective and is compatible with most existing compound microscopes. In general, the only modification required is the addition of a low-cost liquid crystal display at the condenser diaphragm.

Second, the liquid crystal display provides a large degree of freedom for illumination engineering. As a reference, a typical liquid crystal display used for consumer electronics provides more than 400 pixels per inch, which is the equivalent of 800 by 800 pixels over a condenser diaphragm of about 2 inches. This provides orders of magnitudes improvement in degrees of freedom, over the previously demonstrated LED array approach, for controlling spatial coherence and microscope illumination.

Third, the illumination intensity of the disclosed scheme is determined by the light source of the microscope platform. One can use one or multiple high-power light sources to increase the photon budget. For the LED array approach, it is difficult to increase the illumination power since it scales with the size of LED elements.

Fourth, for the disclosed scheme, the illumination from the condenser lens is a plane wave modulated by the active liquid-crystal-display aperture. In contrast, the previously demonstrated LED approach essentially provides an array of spherical wave illumination, necessitating a plane wave approximation of splitting the entire image into small tiles.

Fifth, the intensity of the light source in the disclosed exemplary scheme does not fluctuate as one can set different patterns on the display. For the LED array approach, one generally needs to calibrate for the intensity differences between LED elements and the intensity fluctuations over time. In addition, engineering the condenser aperture using a liquid crystal display is more efficient when illuminating the sample at a large incident angle. For the LED array approach, no lens is placed between the LED array and the sample, and as such, less than 8% of the LED emission from the edge of the array can be delivered to the sample.

In summary, the disclosed illumination-engineering scheme provides a turnkey solution with high flexibility for researchers in various communities. From an engineering point-of view, it may also provide new directions for the development of multimodal microscopy including the recently developed Fourier ptychographic imaging approach.

This Example is structured as follows: in the next section, an exemplary prototype setup of a disclosed illumination scheme is presented. Next, the use of the disclosed scheme for multimodal microscopy is demonstrated. Finally, the exemplary results are summarized, and potential directions are discussed.

### Illumination Engineering Using a Liquid Crystal Display:

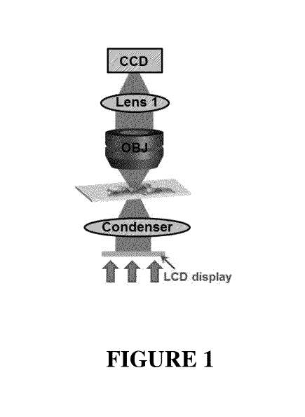

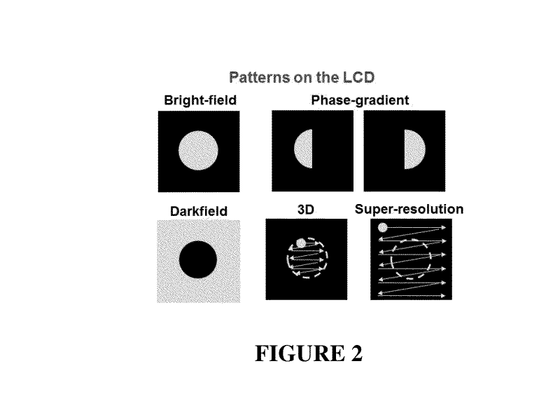

An exemplary illumination-engineering scheme is shown in FIG. 1, where a low-cost liquid crystal display is used as a transparent SLM and placed at the back focal plane of the condenser lens. By showing different binary patterns on the liquid crystal display, one can achieve different microscopy imaging modalities, as shown in FIG. 2.

For bright field microscopy, one can display a circular pattern as shown in FIG. 2, where the pixel transmission is turned off outside the circle. The diameter of the pattern can be adjusted to match to different NAs of the objective lenses. Such an adjustment process is similar to adjusting the size of the condenser diaphragm in other microscope platforms. However, in the disclosed exemplary scheme, this process is performed without any mechanical switching.

Similar to the bright-field microscopy, one can also display a complementary pattern for darkfield microscopy. In this case, the pixel transmission was turned off within the circle. As such, no direct transmission light is able enter the objective lens. This darkfield imaging process is similar to adding a darkfield aperture stop at the condenser diaphragm. It is also noted that, due to the use of the liquid crystal display, the illumination is polarized in the reported platform. One can, therefore, place another polarizer with a different orientation at the detection path to achieve polarization imaging modality.

An interesting microscopy modality is the phase contrast (or phase gradient) imaging. In the disclosed scheme, one can display two complementary semicircular patterns at the liquid crystal display (FIG. 2—phase-gradient) and capture two images I1 and I2 using conventional objective lenses. The phase contrast image of the sample can then be recovered by 2(I1−I2)/(I1+I2). This phase-contrast imaging modality is similar to the scanning differential phase contrast system previously reported where a split-detector or a quadrant diode is placed in the Fourier plane of the collector and the image is formed by subtracting intensities recorded by two halves of the detector. The phase-contrast imaging scheme demonstrated here is a reciprocal system by placing the semicircular aperture stop in the condenser diaphragm instead of the Fourier plane. It is also noted that, in conventional phase contrast microscopy, one should place a ring-aperture at the condenser diaphragm to match the phase plate ring in the phase contrast objective lens. In the disclosed scheme, one can simply show a ring pattern on the liquid crystal display where the pixel transmission is turned off outside the ring pattern.

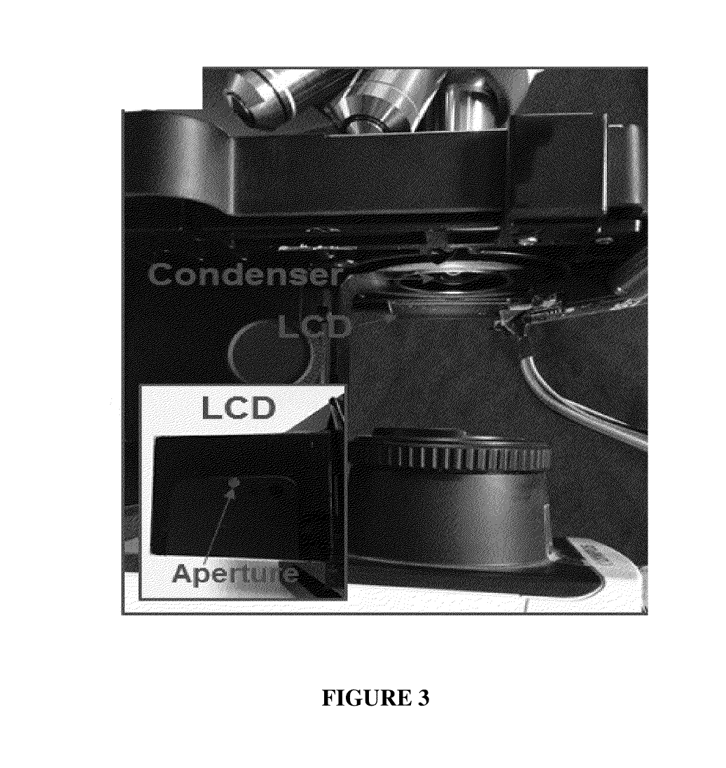

The disclosed scheme can also advantageously be used to perform 3D tomographic imaging. In the disclosed scheme, one can set a scanning aperture pattern on the liquid crystal display (FIG. 2-3D). For each position of the aperture, the illumination is a plane wave with an oblique incident angle. Therefore, by showing a scanning aperture on the display, one can effectively illuminate the sample with different incident angles. With the captured images, one can perform 3D tomographic reconstruction to recover images at different sections. It is noted that, in general, this imaging modality requires the direct transmission light enters the collection optics. Thus, the scanning aperture is restricted within the NA of the collection optics (e.g., the yellow circle in FIG. 2-3D).

Moreover, one can also use the disclosed scheme for super-resolution Fourier ptychographic imaging, a developed computational imaging approach (see, e.g., Zheng et al., Wide-Field, High-Resolution Fourier Ptychographic Microscopy, Nat. Photonics 7(9), 739-745 (2013)). In brief, FP illuminates the sample with different oblique incident angles and captures the corresponding intensity images using a low-NA objective lens. The captured images are then judicially combined in the Fourier domain to recover a high-pixel-count sample image that surpasses the diffraction limit of the employed optics. The recovery process of FP switches between the spatial and the Fourier domain. In the spatial domain, the captured images are used as the intensity constraint for the solution. In the Fourier domain, the confined pupil function of the objective lens is used as the support constraint for the solution. This pupil function constraint is digitally panned across the Fourier space to reflect the angular variation of its illumination. In the disclosed scheme, one can simply show a scanning aperture across the liquid crystal display (FIG. 2—super-resolution). In contrast to the 3D imaging case, the illumination NA here is larger than the collection NA to enable super resolution imaging. Therefore, the scanning aperture is typically not restricted by the NA of the objective lens, as shown in FIG. 2—super-resolution.

One exemplary experimental setup of the disclosed scheme is shown in FIG. 3. In this exemplary platform, we used a conventional microscope platform (Olympus CX41) with a low-cost liquid crystal display (1.8 inch, 160 by 128 pixels, Amazon). The backlight of the display was removed and was used as a transparent SLM. A micro-controller was used for showing different binary patterns on the display. To build the prototype platform, one typically only needs to place the display at the back focal plane of the condenser lens, as shown in FIG. 3. In general, no other modification is needed. Therefore, the disclosed exemplary platform provides a turnkey solution for microscopy users in different communities and settings.

### Multimodal Imaging Demonstration Using the Reported Platform:

Here, the versatility of the disclosed scheme for multimodal microscopy imaging is demonstrated.

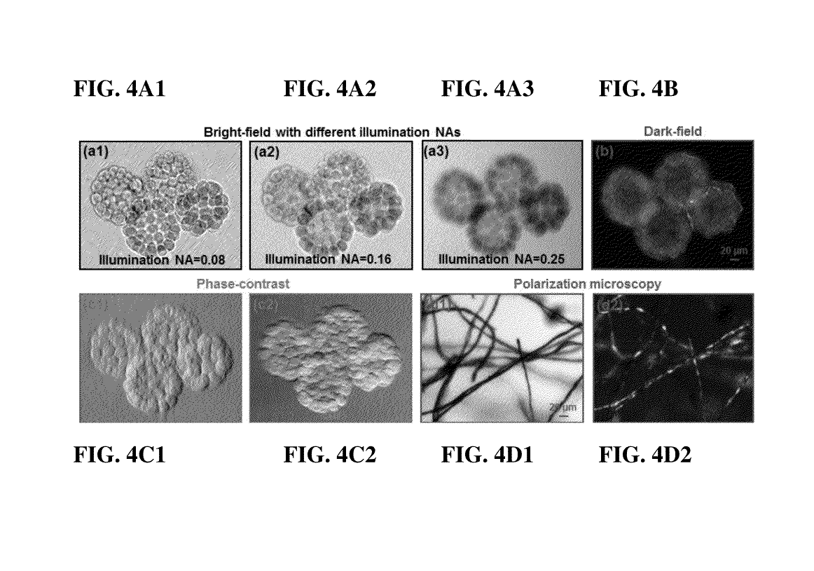

FIG. 4A1, FIG. 4A2, FIG. 4A3 and FIG. 4B show the bright-field and dark-field images of a starfish embryo sample. We note that, for the dark-field image in FIG. 4B, a reference image was captured by setting the display to the ‘off state’ and subtracting this reference image to enhance the contrast. FIG. 4A1, FIG. 4A2 and FIG. 4A3 show bright field images with different illumination NAs, corresponding to different degrees of the spatial coherence.

FIG. 4C1 and FIG. 4C2 show the phase gradient (contrast) images along different directions for the same sample. For each of these phase contrast images, two raw images were captured corresponding to the two complementary half-circular patterns at the display, and they were processed as discussed in the previous section. FIG. 4D1 and FIG. 4D2 (cotton fibers) show the polarization microscopy images by adding a polarizer at the detection path. In FIG. 4D1, the orientation of the added polarizer is the same as the liquid crystal display. In FIG. 4D2, the polarizer was rotated by 90 degrees and the sample contrast came from the rotation of the polarized light. A 10×, 0.25 objective lens was utilized for FIGS. 4A1 to 4D2.

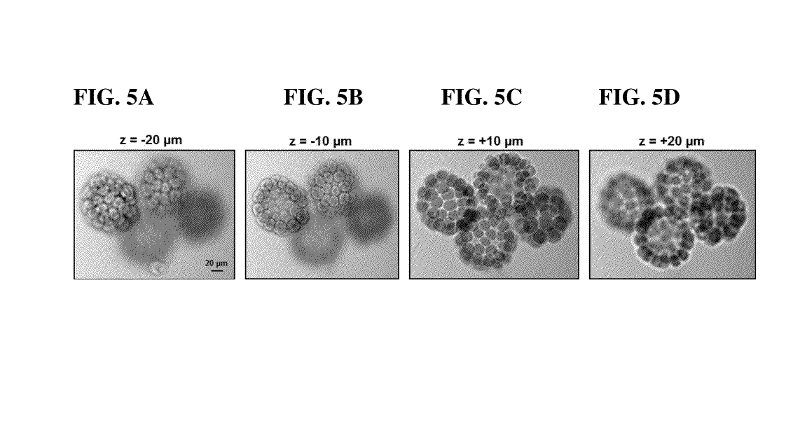

FIGS. 5A-5D show the 3D tomographic imaging capability of the disclosed platform. In this experiment, 49 images were captured by showing a scanning aperture pattern on the display. A 10×, 0.25 objective lens was utilized in this demonstration. The captured images were then utilized to recover images at different sections. The reconstruction process is the same as the tomographic reconstruction reported in Zheng et al., Microscopy Refocusing And Dark-Field Imaging By Using A Simple LED Array, OPTICS LETTERS, Vol. 36(20) 2011.

From FIGS. 5A-5D, one can see that different parts of the starfish embryo sample are in-focus at different recovered sections. The entire digital refocusing process was shown from −40 μm to +40 μm.

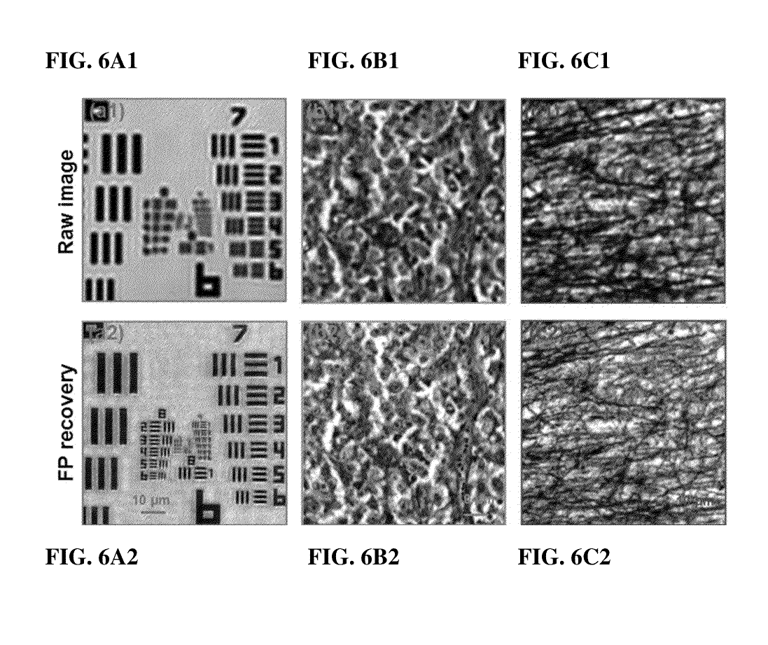

Lastly, the exemplary disclosed platform was tested for super-resolution Fourier ptychographic microscopy. The image acquisition process is similar to that of the 3D tomographic imaging case. However, in this case, the illumination NA should be larger than the collection NA to achieve the super-resolution imaging capability. In an exemplary implementation, 121 raw images were captured corresponding to a scanning aperture pattern at different positions on the display. A 4×, 0.1 NA objective in the acquisition process was utilized, and the captured images were then synthesized in the Fourier domain to increase the synthetic NA to about 0.5. FIG. 6A1 shows the raw image of an USAF resolution target, and FIG. 6A2 shows the recovered image with a synthetic NA of 0.5.

We also tested the reported platform for biological samples. FIG. 6B1 and FIG. 6C1 show the raw images of a pathology slide and a mouse brain section. The corresponding super-resolution recoveries are shown in FIG. 6B2 and FIG. 6C2. Raw data also showed the 121 raw images of the mouse brain section. This exemplary super-resolution imaging experiment demonstrated the high flexibility of the disclosed illumination-engineering scheme.

### Summary and Discussion:

A simple and effective approach for microscopy illumination engineering has been demonstrated. The exemplary disclosed approach is cost-effective and compatible with most existing platforms. On the application front, the versatility of the disclosed platform for multimodal imaging of biological samples has been demonstrated. By presenting different patterns on the liquid crystal display, one is able to perform bright-field microscopy, darkfield microscopy, phase-contrast microscopy, polarization microscopy, 3D tomographic imaging, and superresolution Fourier ptychographic imaging. The disclosed scheme may further find applications in phase tomography, where angle-varied plane waves are used for sample illumination.

It can also be used in field-portable Fourier ptychographic microscope for active illumination control. With further modification, the liquid crystal display can also be placed at the Fourier plane of a 4f system to perform aperture-scanning Fourier ptychographic imaging for 3D holography and aberration correction.

One potential limitation of a disclosed prototype platform is the low extinction ratio of the liquid crystal display. This ratio is about 300 in one prototype setup, and thus, the ‘on-state’ transmission is only 300 times higher than that of the ‘off-state’. This relative low extinction ratio can lead to a residue background of the captured image, especially for images with large incident angles. Although one can subtract this background from the measurements, the noise can remain in the images. One of the future directions is to increase the extinction ratio by putting two displays together. In that case, the extinction ratio would be about 100,000 instead of 300. Finally, one can also use multiplexing scheme to improve the light delivering efficiency. For example, one can scan multiple apertures and/or turn on multiple wavelengths at the same time to increase the photon budget.

### Example 2

### Illumination Control/Computational Imaging: Multimodal Microscopy Using a Low-Cost Liquid Crystal Display

Traditional condenser lenses should be physically adjusted to meet the needs of different microscopy modalities. But a low-cost liquid crystal display (LCD), serving as a transparent spatial light modulator in a microscopy platform, enables active illumination control for multiple imaging approaches.

The condenser lens system, typically consisting of a high-numerical-aperture (NA) lens and a diaphragm at the lens' back focal plane, is an important component of a traditional microscope. The diaphragm allows for manual adjustment of the illumination aperture, which is important because various microscopy techniques require vastly different condenser illumination. Meeting these requirements is currently a matter of physically adjusting the condenser diaphragm, or else using specialized condenser apertures.

As noted above, various microscopy techniques require vastly different condenser illumination. Stated another way, different microscopy techniques have vastly distinct illumination requirements. For instance, in brightfield microscopy, various NAs can be used for sample illumination. Resolution is determined by 1.22λ/(NA_{obj}+NA_{condenser}), with NA_{condenser}<=NA_{obj}. A small-illumination NA produces images with relatively limited spatial resolution, high image contrast, and long depth of field. A large-illumination NA, on the other hand, produces images with higher spatial resolution, but with lower image contrast and shorter depth of field. For many brightfield imaging applications, the achievable resolution is an important factor for consideration; thus, one typically adjusts the size of the condenser diaphragm to match the NA of the employed objective lens. In darkfield microscopy, the illumination angle should be greater than the maximum collection angle of the objective lens, and placing an aperture stop at the condenser diaphragm ensures that substantially no zero-order light will enter the objective lens. And in phase-contrast microscopy, a ring aperture is placed at the condenser diaphragm to match to the ring-shape phase plate of the objective lens.

In exemplary embodiments, the present disclosure provides for cost-effective, active control of the illumination system. In exemplary embodiments, liquid crystal display (LCD) technology offers just this type of functionality. For example, placing an LCD (instead of a diaphragm) at the back focal plane of a condenser lens enables showing of different patterns directly on the display, without making physical adjustments. Furthermore, the LCD can be used in conjunction with computational imaging techniques to achieve microscopy modalities not possible in a standard microscope platform.

### Imaging in Five Modalities:

In exemplary embodiments, the present disclosure provides for this type of setup (e.g., placing an LCD (instead of a diaphragm) at the back focal plane of a condenser lens to enable showing of different patterns directly on the LCD without making physical adjustments; the LCD can be used in conjunction with computational imaging techniques to achieve microscopy modalities not possible in a standard microscope platform).

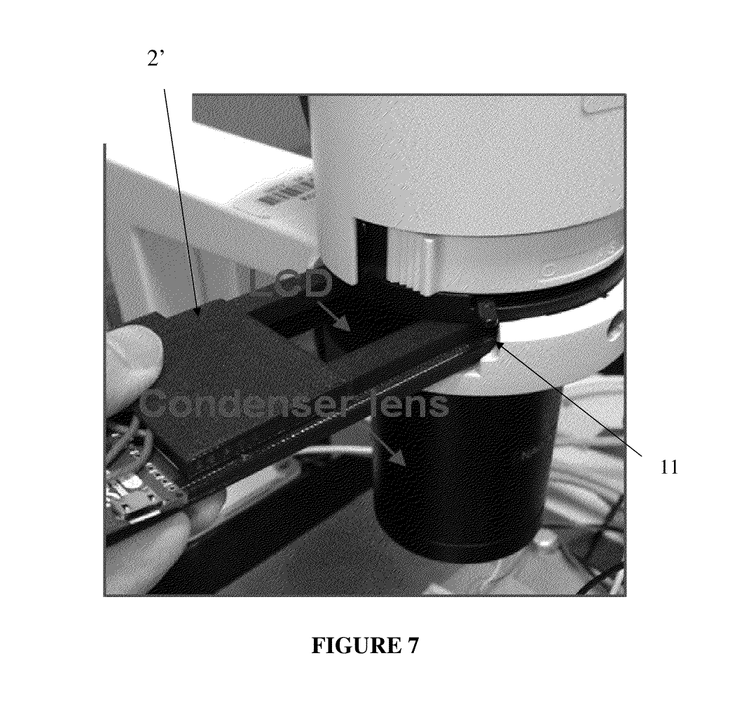

In certain embodiments, a low-cost LCD operates as a transparent spatial light modulator (see FIG. 1) in both upright and inverted microscope platforms (see FIG. 3 and FIG. 7). The patterns it generates correspond to different imaging modalities (see FIG. 2).

For brightfield microscopy, the LCD can display a circular pattern where the pixel transmission is turned off outside the circle. One can adjust the size of circular pattern to match different NAs of the objective lenses.

Similarly, one can display a complementary pattern for darkfield imaging. In this case, the pixel transmission should be turned off within the circle.

For the phase-contrast modality, one can display two complementary semicircular patterns at the LCD, capture two corresponding sample images, and get the difference between them.

Because use of an LCD enables polarization of light in the illumination path, one can place another polarizer with a different orientation at the detection path to achieve polarization imaging.

The disclosed scheme can also be used to perform 3D tomographic imaging (for an LED-array approach, see, e.g., Zheng et al., Microscopy Refocusing And Dark-Field Imaging By Using A Simple LED Array, OPTICS LETTERS, Vol. 36(20) 2011).

Here, instead of using an LED array, one can set a scanning aperture pattern on the LCD. For each position of the aperture, the illumination is a plane wave with an oblique incident angle. Therefore, by showing a scanning aperture on the display, one can effectively illuminate the sample with different incident angles. The corresponding captured images can then be used to recover the 3D sample images using the tomographic reconstruction routine. It is noted that 3D tomographic imaging generally requires that direct transmission light enter the collection optics, thus, the scanning aperture is restricted within the NA of the collection optics (e.g., the yellow circle in FIG. 2-3D).

Using a starfish embryo specimen, the versatility of the proposed platform for multimodal microscopic imaging was demonstrated (see FIGS. 4-5). It was applied in both brightfield and darkfield imaging (see FIGS. 4A1, 4A2, 4A3 and 4B), the former with different illumination NAs corresponding to different degrees of the spatial coherence.

In addition, phase-contrast imaging was accomplished along different directions for the same sample. For each of the phase contrast results, a pair of raw images was captured corresponding to the two complementary half-circular patterns at the LCD, and the difference between them was calculated.

FIGS. 4D1 and 4D2 show the polarization image of a cotton fibers sample. In FIG. 4D1, the orientation of the added polarizer is the same as the LCD; in FIG. 4D2, the polarizer was rotated by 90° and the sample contrast came from the rotation of the polarized light.

FIGS. 5A-D depict the results of 3D tomographic imaging of the starfish embryo.

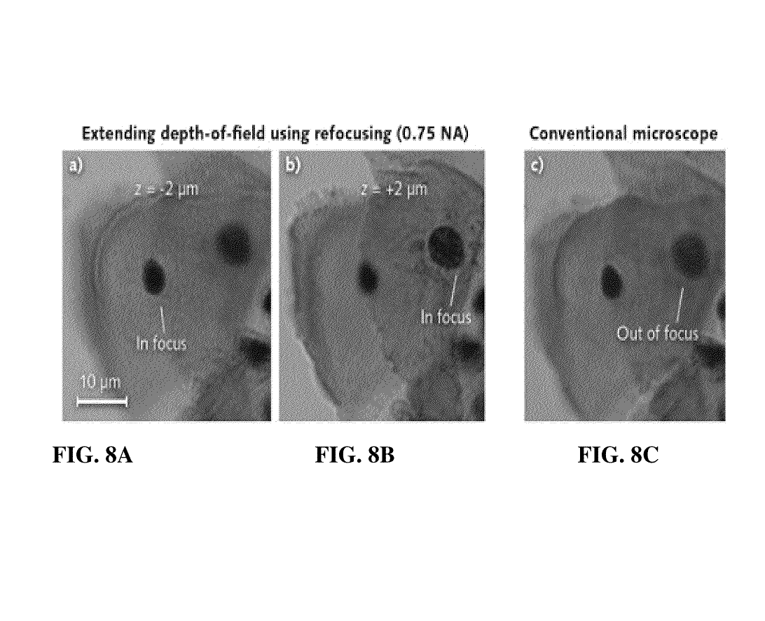

Forty-nine images were captured by showing a scanning aperture pattern on the LCD, and were then processed by using a tomographic reconstruction routine. It is noted that different parts of the starfish embryo sample are in focus at different recovered sections. This modality has the advantage of combining long depth of field with high spatial resolution (see FIGS. 8A-C). Using a small aperture at the LCD for sample illumination enables extension of the depth of focus; on the other hand, the tomographic reconstruction process enables improvement of spatial resolution to the level of conventional incoherent imaging settings.

FIGS. 8A-8B show recovered images of a pap smear that demonstrate the depth-of-field extension using a 3D tomographic reconstruction routine. By comparison and as shown in FIG. 8C, a conventional incoherent brightfield image uses a relatively large illumination NA to produce a smaller depth of field. A 40×, 0.75 objective was utilized in this demonstration.

### Super-Resolution Fourier Ptychographic Imaging:

The exemplary scheme is also useful for super-resolution Fourier ptychographic (FP) imaging (see, e.g., Zheng et al., Nature Photon., 7, 739-745 (2013)). This approach illuminates the sample with different oblique incident angles and captures the corresponding intensity images using a low-NA objective lens. Captured images are then combined in the Fourier domain to recover a complex image that surpasses the diffraction limit of the employed optics.

The recovery process of FP switches between spatial and Fourier domains. In the spatial domain, the captured images are used as the intensity constraint for the solution. In the Fourier domain, the confined pupil function of the objective lens is used as the support constraint for the solution. In the proposed LCD-based setup, one can simply set a scanning aperture across the LCD to get different illumination angles.

In contrast to 3D tomographic imaging, for FP the illumination NA should be larger than the collection NA for super-resolution imaging. Therefore, the scanning aperture is not restricted by the NA of the objective lens, as shown in FIG. 2—super-resolution. In the disclosed implementation, 121 raw images were captured corresponding to a scanning aperture pattern at different positions on the LCD. A 4×, 0.1 NA objective lens was utilized in the acquisition process, and the captured images were synthesized in the Fourier domain to increase the synthetic NA to 0.5. FIGS. 6A1-6C2 show raw images and super-resolution FP reconstructions.

FIGS. 6A1 and 6C1 show raw images of a USAF resolution target (FIG. 6A1) and a mouse brain section (FIG. 6C1) These images are starting points for super-resolution Fourier ptychographic imaging using the LCD-based scheme. Corresponding processed images of the two samples depict recovered super-resolution output (FIGS. 6A2 and 6C2).

In summary, illumination engineering is important for obtaining high-resolution, high-quality microscopy images. The LCD-based illumination approach provides a turnkey solution with extraordinary flexibility for researchers in various fields. From an engineering point of view, it may also provide new directions for the development of multimodal microscopy, including the recently developed Fourier ptychographic imaging approach.

### Example 3

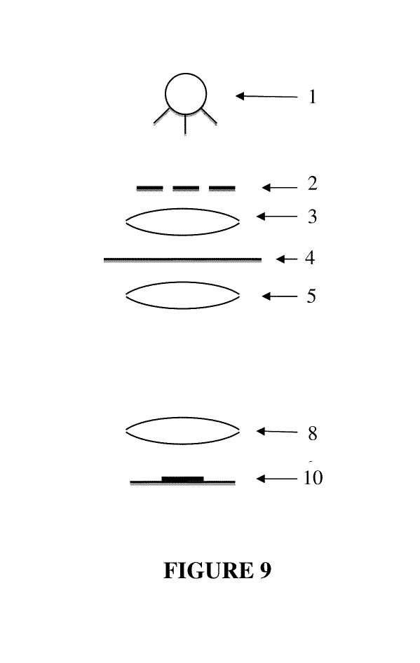

This Example provides various embodiments to the imaging assemblies discussed above. As noted in Examples 1 and 2 above, FIG. 9 shows the imaging assembly having a light source 1, a condenser 3, the sample 4, the objective or other detection optics 5, the tube lens or camera adapter 8, and the imaging sensor 10. In this embodiment, the SLM 2 (e.g., digitally controlled LCD or DMD 2) is positioned between the light source 1 and the condenser 3 (e.g., between the light source 1 and the backfocal plane of the condenser 3) for imaging purposes (e.g., for 3D tomographic imaging using computational image reconstruction with brightfield or fluorescence illumination; for illumination modulation and 3D tomography).

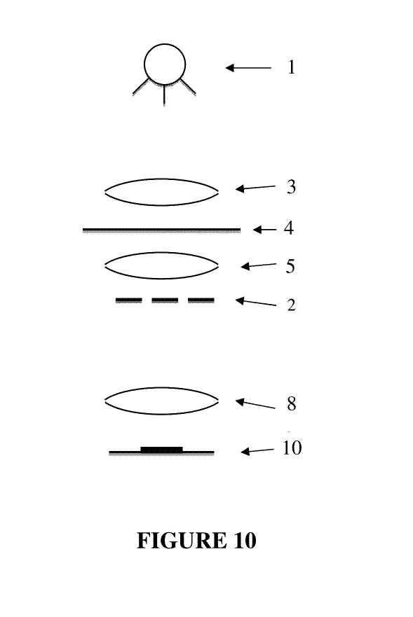

In an alternative embodiment and as shown in FIG. 10, the imaging assembly can include the SLM 2 (e.g., digitally controlled LCD or DMD 2) positioned at the backfocal plane of the detection optic element 5 (e.g., the objective or other detection optics 5) for imaging purposes (e.g., for 3D imaging with transmitted fluorescence illumination).

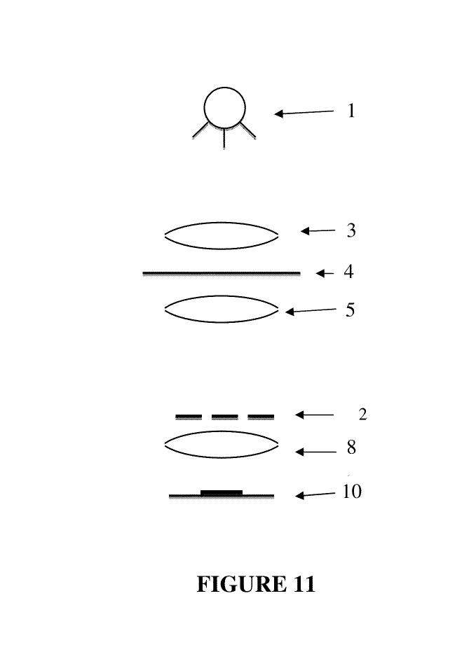

In another alternative embodiment and as shown in FIG. 11, the imaging assembly can include the SLM 2 (e.g., digitally controlled LCD or DMD 2) positioned between the tube lens/camera adapter 8 and the objective 5 (e.g., between the front focal of the tube lens and the tube lens 8) for imaging purposes (e.g., for 3D imaging with epifluorescence illumination).

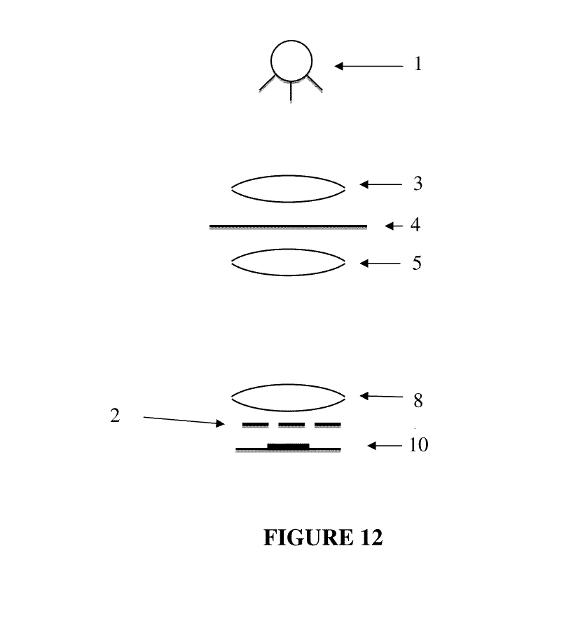

In another alternative embodiment and as shown in FIG. 12, the imaging assembly can include the SLM 2 (e.g., digitally controlled LCD or DMD 2) positioned below the tube lens/camera adapter 8 and above the imaging sensor 10 for imaging purposes (e.g., for 3D imaging with epifluorescence illumination).

As shown in FIG. 7, the SLM 2′ can take the form of a SLM slider member 2′ or the like, with the SLM slider member 2′ having integrated LCD (or DMD) and electronics. In exemplary embodiments and as shown in FIG. 7, the SLM slider 2′ can be inserted into the light path/opening 11 (instead of the standard phase annuli or dark-field stops on the illumination side of the microscope) for imaging purposes.

It is noted that instead of slider 2, the SLM slider 2′ could be positioned above the tube lens/camera adapter 8 (and below the objective 5) for imaging purposes, or the SLM slider 2′ could be positioned below the tube lens/camera adapter 8 and above the imaging sensor 10 for imaging purposes (e.g., for fluorescence 3D tomographic imaging).

Although the systems/methods of the present disclosure have been described with reference to exemplary embodiments thereof, the present disclosure is not limited to such exemplary embodiments/implementations. Rather, the systems/methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

The ranges disclosed herein are inclusive of the endpoints, and the endpoints are independently combinable with each other. Each range disclosed herein constitutes a disclosure of a point or sub-range lying within the disclosed range.

The use of the terms “a” and “an” and “the” and words of a similar nature in the context of describing the improvements disclosed herein (especially in the context of the following claims) are to be construed to cover both the singular and the plural, unless otherwise indicated herein or clearly contradicted by context. Further, it should be noted that the terms “first,” “second,” and the like herein do not denote an order, quantity, or relative importance, but rather are used to distinguish one element from another. The modifier “about” used in connection with a quantity is inclusive of the stated value and has the meaning dictated by the context (e.g., it includes, at a minimum the degree of error associated with measurement of the particular quantity).

The methods described herein can be performed in a suitable order unless otherwise indicated herein or otherwise clearly contradicted by context. The use of examples, or exemplary languages (e.g., “such as”), is intended merely to better illustrate the disclosure and does not pose a limitation on the scope of the disclosure or an embodiment unless otherwise claimed.

1. An imaging assembly comprising:
a light source and an imaging sensor;
a condenser, a detection optics member and a tube lens or camera adapter, the condenser, detection optics member and the tube lens or camera adapter positioned between the light source and the imaging sensor; and
a digitally controlled spatial light modulator positioned between the light source and the imaging sensor, the digitally controlled spatial light modulator configured and adapted to provide three-dimensional tomographic imaging of a sample.

2. The assembly of claim 1, wherein the digitally controlled spatial light modulator is a liquid crystal display or a digital micro-mirror device.

3. The assembly of claim 1, wherein the three-dimensional tomographic imaging of the sample utilizes computational image reconstruction with brightfield or fluorescence illumination.

4. The assembly of claim 1, wherein the digitally controlled spatial light modulator is configured and adapted to provide illumination modulation.

5. The assembly of claim 1, wherein the three-dimensional tomographic imaging of the sample utilizes brightfield illumination, fluorescence illumination or epifluorescence illumination.

6. The assembly of claim 1, wherein the digitally controlled spatial light modulator is positioned between the light source and the condenser.

7. The assembly of claim 1, wherein the digitally controlled spatial light modulator is positioned at the back focal plane of the condenser.

8. The assembly of claim 1, wherein the digitally controlled spatial light modulator is positioned at the back focal plane of the detection optics member.

9. The assembly of claim 1, wherein the digitally controlled spatial light modulator is positioned between the detection optics member and the tube lens or camera adapter.

10. The assembly of claim 1, wherein the digitally controlled spatial light modulator is positioned between the tube lens or camera adapter and the imaging sensor.

11. The assembly of claim 1, wherein the digitally controlled spatial light modulator is a slider member having an integrated liquid crystal display and electronics, the slider member configured and dimensioned to be inserted into the light path of the light source for imaging purposes.

12. The assembly of claim 1, wherein the digitally controlled spatial light modulator is a slider member having an integrated liquid crystal display and electronics, the slider member configured and dimensioned to be positioned between the detection optics member and the tube lens or camera adapter for imaging purposes.

13. The assembly of claim 1, wherein the digitally controlled spatial light modulator is a slider member having an integrated liquid crystal display and electronics, the slider member configured and dimensioned to be positioned between the tube lens or camera adapter and the imaging sensor for imaging purposes.

14. An imaging method, comprising:
providing a light source and an imaging sensor;
providing a condenser, a sample, a detection optics member and a tube lens or camera adapter, the condenser, sample, detection optics member and the tube lens or camera adapter positioned between the light source and the imaging sensor;
positioning a digitally controlled spatial light modulator between the light source and the imaging sensor;
providing three-dimensional tomographic imaging of the sample via the digitally controlled spatial light modulator.

15. The method of claim 14, wherein the digitally controlled spatial light modulator is configured and adapted to provide illumination modulation; and
wherein the digitally controlled spatial light modulator is a liquid crystal display or a digital micro-mirror device.

16. The method of claim 14, wherein the three-dimensional tomographic imaging of the sample utilizes computational image reconstruction with brightfield or fluorescence illumination.

17. The method of claim 14, wherein the three-dimensional tomographic imaging of the sample utilizes brightfield illumination, fluorescence illumination or epifluorescence illumination.

18. The method of claim 14, wherein the digitally controlled spatial light modulator is positioned between the light source and the condenser.

19. The method of claim 14, wherein the digitally controlled spatial light modulator is positioned between the detection optics member and the tube lens or camera adapter.

20. The method of claim 14, wherein the digitally controlled spatial light modulator is positioned between the tube lens or camera adapter and the imaging sensor.

21. The method of claim 14, wherein the digitally controlled spatial light modulator is a slider member having an integrated liquid crystal display and electronics, the slider member configured and dimensioned to be inserted into the light path of the light source for imaging purposes.

22. An imaging assembly comprising:
a light source and an imaging sensor;
a condenser, a detection optics member and a tube lens or camera adapter, the condenser, detection optics member and the tube lens or camera adapter positioned between the light source and the imaging sensor; and
a digitally controlled liquid crystal display positioned between the light source and the imaging sensor, the digitally controlled liquid crystal display configured and adapted to provide three-dimensional tomographic imaging of a sample using computational image reconstruction with brightfield or fluorescence illumination;
wherein the digitally controlled liquid crystal display is configured and adapted to provide illumination modulation; and
wherein the digitally controlled liquid crystal display is positioned at the back focal plane of the condenser.
